(19) United States
(12) Patent Application Publication
(10) Pub. No.: US 2007/0022470 A1
(43) Pub. Date: Jan. 25, 2007

(54) Universal security management system, device and method for network management

(75) Inventor: Bo Yang, Shenzhen (CN)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Huawei Technologies Co., Ltd., Shenzhen (CN)

(21) Appl. No.: 11/489,932

(22) Filed: Jul. 20, 2006

(30) Foreign Application Priority Data
Jul. 21, 2005 (CN) 200510036123.1

(51) Int. Cl. H04L 9/32

(52) U.S. Cl. 726/3

(57) ABSTRACT

The present invention relates to network management technologies for communication systems, and discloses a security management system, device and method for network management of communication devices, implementing a centralized, universal security management for network management in a communication network which includes network devices provided by various manufacturers. In the present invention, the network devices, that is, function entities, provided by different device manufacturers, are divided into different security domains; in each security domain there is arranged at least one security management gateway which is adapted to adapt a security management interface in the security domain to a universal security management interface. Moreover, there is provided a security management user interface to the security administrator. The security management system of the present invention runs through four work flows, i.e., user management, user authorization, user verification, and user authentication. Both the security management gateway and the function entities are logical entities.

### FIELD OF THE INVENTION

The present invention relates to network management technologies for communication systems, and particularly to security management system, device and method for network management of communication devices.

### BACKGROUND OF THE INVENTION

With the arrival of the information times and the rapid development of national economy, building speed of communication networks, particularly of mobile communication networks is striking, and the number of mobile users has exploded. The expansion of the network scale, the incessant renovation of new technologies, and the increase of the different vendors' network elements cause the difficulty of network management increased, and the requirement on Network Management System (NMS) is also higher and higher. In order to manage the modern communication networks scientifically, bring the scale benefit thereof into play, and implement centralized management and uniform control, each carrier builds a NMS for its own network.

The NMS is generally responsible for monitoring, configuring and fault diagnosing of network devices. The main functions of a NMS include automatic topology discovery, remote configuration, performance parameter monitoring, and fault diagnosis. Various NMSs are mainly developed by two kinds of enterprises; one is the universal network management software providers, and the other is the respective network device providers who provide network management solutions with respect to their own products.

A specific NMS system designed by a device manufacturer for its own products has very comprehensive functions of monitoring and configuration for its own products, which is capable of monitoring some important performance specifications that can't be monitored by the universal NMS, and also has some particular configuration functions. But such a specific NMS system is helpless to other manufacturers' network devices.

Security management is an important part of network management, which mainly implements management of account information and rights of network administrators, guaranteeing secure accesses and operations to the network devices by the legal network management users, and preventing operations without authorization. Security management includes functions, such as authorization, user verification, access control and security logging, etc. A reliable security management mechanism has a vital effect on the whole NMS, and even on the security and reliability of the whole network.

In a large-scale communication network, especially in a carrier's network, because of the network development and the service diversification, it is generally unavoidable that there are various devices or systems provided by multiple device manufacturers. In order to ensure safe running, these devices or systems all provide their independent NMSs, which surely also include security management systems. However, as mentioned above, since the NMSs or the security management systems of different device manufacturers' devices or systems are not compatible and collaborative with each other, a centralized user management, right management and identity verification within the whole network can't be implemented.

However, carriers of large-scale networks urgently need a centralized whole-network security management system which is universal to devices of various device manufacturers, so that centralized user management, right management and identity verification can be made for NMSs (or modules) of all devices or systems within the whole network, so as to decrease the operating difficulty of the communication network and to improve the security thereof.

At present, there is no related technical solution, which can implement a centralized whole-network security management for network management of a communication network which involves devices produced by various manufacturers. This situation is a serious obstacle for the development of communication networks, the incensement of network service quality, and the improvement of network security.

### SUMMARY OF THE INVENTION

The present invention provides a universal security management system for network management, device and method, which implements a centralized, universal security management for network management in a communication network which includes network devices provided by various manufacturers.

According to one aspect of the present invention, there is provided a universal security management system for network management, comprising a Security Management Center (SMC), at least one Function Entity (FE) and at least one Security Management Gateway (SMG); wherein

the whole network is divided into at least one Security Domain (S-Domain), each S-Domain comprising at least one said FE; and

each said S-Domain corresponds to at least one said SMG which is adapted to adapt a Security Management Interface (SMI) of the at least one FE in the S-Domain to a Universal Security Management Interface (USMI) provided by the SMC.

Wherein, the universal security management system for network management further comprises a Security Management User Interface (SMUI) which is adapted to provide a user interface of security management to the administrator based on the SMC.

Furthermore, in said system, the SMC is adapted to manage user information, authorization information and identity verification information of the whole network,

to interact with the FEs in the whole network through the SMGs of the S-Domains, and

to interact with the administrator through the SMUI.

Furthermore, in said system, the FE is adapted to forward user verification requests to the SMG of the S-Domain the FE pertains to, to download the right information of the user currently logging in from the SMC through the SMG and buffer the right information, to authenticate a user operation according to the right information, and to clear the buffer of the right information at the time of the user's logout or according to pre-configured policies.

Furthermore, in said system, the SMG interacts with all the FEs in the S-Domain the SMG pertains to through the SMI of the S-Domain, and interacts with the SMC through the USMI, for forwarding the user verification requests sent by the FEs to the SMC, and forwarding the right information sent by the SMC to the FEs.

In another aspect of the present invention, there is also provided a universal security management system for network management, comprising a Security Management Center (SMC), at least one Function Entity (FE) and at least one Security Management Gateway (SMG); wherein

said at least one FE is adapted to process user services;

said SMC is adapted to implement the security management of the whole network; and

said at least one SMG each corresponds to at least one FE, which is adapted to implement a data interaction between the SMC and the at least one FE the SMG corresponds to.

Furthermore, in said system, the SMG interacts with the corresponding FE through a Security Management Interface (SMI) of the FE, and interacts with the SMC through a Universal Security Management Interface (USMI) provided by the SMC.

In a further aspect of the present invention, there is provided a Security Management Gateway (SMG) for network management, which corresponds to at least one Function Entity (FE), and implements an interaction between the FE and a Security Management Center (SMC) of a Network Management System (NMS), comprising:

an FE interaction unit, adapted to implement a data interaction with the FE;

an SMC interaction unit, adapted to implement a data interaction with the SMC; and

a processing unit, adapted to implement the adaptation of the data transmitted between the FE interaction unit and the SMC interaction unit.

Furthermore, in said SMG for network management, the FE interaction unit interacts with the corresponding FE through the SMI of the FE; the SMC interaction unit interacts with the SMC through a Universal Security Management Interface provided by the SMC.

Furthermore, in said SMG for network management, the processing unit comprises:

a verification request processing unit, adapted to convert a user verification request received by the FE interaction unit from the FE, and then to send the converted user verification request to the SMC through the SMC interaction unit; and

a right information processing unit, adapted to convert a user verification result received by the SMC interaction unit from the SMC, and then to send the converted user verification result to the FE through the FE interaction unit.

In yet another aspect of the present invention, there is provided a Security Management Center (SMC), comprising a Universal Security Management Interface (USMI), wherein the SMC further comprises:

a Function Entity interaction unit, adapted to implement a data interaction with a Function Entity (FE); and

an adaptation unit, adapted to implement an adaptation of the data transmitted between the USMI and the FE interaction unit.

In yet another aspect of the present invention, there is provided a Function Entity (FE) of a security management system for network management, comprising a Security Management Interface (SMI); wherein the FE further comprises:

a Security Management Center interaction unit, adapted to implement a data interaction with a Security Management Center (SMC); and

an adaptation unit, adapted to implement an adaptation of the data transmitted between the SMI and the SMC.

According to yet another aspect of the present invention, there is provided A method for user management of a universal security management system for network management, comprising the following steps of

receiving, through a Security Management User Interface (SMUI), a user management operation request from an administrator, and sending the user management operation request to a Security Management Center (SMC);

processing, at the SMC, the user management operation request, and returning a processing result to the SMUI; and

displaying the processing result, by the SMUI, on a user interface.

In yet another aspect of the present invention, there is provided a method for user authorization of a universal security management system for network management, comprising the following steps of

receiving, through a Security Management User Interface (SMUI), a user authorization operation request from an administrator, and sending the user authorization operation request to a Security Management Center (SMC);

obtaining, by the SMC, the information of authorizable operating type and authorizable operating object from a Security Management Gateway (SMG), and returning the information of authorizable operating type and authorizable operating object to the SMUI;

displaying, by the SMUI, the information of authorizable operating type and authorizable operating object on an administrator interface for the administrator's reference when the administrator performs an authorization operation;

sending, through the SMUI, the user authorization operation request to the SMC after the authorization operation is accomplished by the administrator;

processing, at the SMC, the authorization operation, saving the user authorization information, and returning a processing result to the SMUI; and

displaying, by the SMUI, the processing result on an administrator interface.

In yet another aspect of the present invention, there is also provided A method for user authorization of a universal security management system for network management, comprising the following steps of

obtaining, by a Security Management Center (SMC), information of authorizable operating type and authorizable operating object from a Security Management Gateway (SMG) each time the SMC starts up, and saving the information by the SMC in local;

initiating, by the SMG, a synchronizing procedure with the SMC after each time of the update and the modification of the SMG, so as to maintain the synchronization of the information of authorizable operating type and authorizable operating object between the SMG and the SMC;

performing, by the administrator, an authorization operation according to the information of authorizable operating type and authorizable operating object provided by the SMC;

sending, through a Security Management User Interface (SMUI), an authorization operation request to the SMC after the authorization operation;

processing, at the SMC, the authorization operation, saving the user authorization information, and returning a processing result to the SMUI; and

displaying, by the SMUI, the processing result on an administrator interface.

In yet another aspect of the present invention, there is provided a method for user verification of a universal security management system for network management, comprising the following steps of

receiving, by a Function Entity (FE), a user verification request, and sending the user verification request to a Security Management Gateway (SMG) of the Security Domain (S-Domain) that the FE pertains to, and forwarding, by the SMG, the user verification request to a Security Management Center (SMC);

processing, at the SMC, the user verification request and then returning a verification result and user right information to the SMG, and forwarding, by the SMG, the verification result and the user right information to the FE; and

buffering, by the FE, the user right information in local until the user logs out or a time limit expires.

Furthermore, in said method for user verification of a universal security management system for network management, the step of receiving by the FE the user verification request further comprises determining, by the FE, whether to forward the user verification request or not according to pre-configured local policies; if it is yes, forwarding the user verification request to the SMG, otherwise directly processing the user verification request in local; before the step of buffering by the FE the user right information in local, the method further comprises determining, by the FE, whether to buffer the user right information or not according to the pre-configured local policies.

In yet another aspect of the present invention, there is provided A method for user authentication of a universal security management system for network management, comprising the following steps of

authenticating, by a Function Entity (FE), a user operation according to user right information buffered in local, and executing the user operation, by the FE, after passing the authentication; and

clearing, by the FE, the locally buffered user right information according to pre-configured policies when the user logs out or a time limit expires.

It can be seen by comparing that the technical solution of the present invention differs from the prior art mainly in that the network devices, that is, function entities, provided by different device manufacturers, are divided into different security domains; in each security domain there is arranged at least one security management gateway which is adapted to adapt a security management interface in the security domain to a universal security management interface; through which universal security management interface the centralized security management for the function entities in the whole network by a security management center can be achieved; moreover, there is provided a security management user interface to the security administrator;

the security management system of the present invention runs through four work flows, i.e., user management, user authorization, user verification, and user authentication;

the interaction between different function entities and the security management center is implemented through the security management gateway; and

the forwarding of the user verification request, the downloading and buffering of the user right information is implemented by improving the function entity.

The difference between the technical solutions brings comparatively obvious beneficial effect, that is, the provision of the security management center and the universal security management interface implements the basis of the centralized security management, and the division of the security domains and the adaptation of the security management gateway implements the universal management for the different function entity in the whole network; therefore, a centralized user management, right management and user verification mechanisms can be achieved by using a uniform approach, without large-scale modifications to the existing devices, thus simplifying the network management, avoiding the confusion due to the variance of multiple security management interface, and improving the security and reliability of the network.

### BRIEF DESCRIPTION OF THE DRAWINGS

The objects, technical solutions and advantages of the present invention will become apparent with reference to the following detailed description of the present invention in conjunction with the accompanying drawings, wherein:

FIG. 1 is a block diagram of the universal security management system for network management according to an embodiment of the present invention;

FIG. 2 is a flow diagram of the user management operation of the universal security management system for network management according to an embodiment of the present invention;

FIG. 3 is a flow diagram of the user authorization operation of the universal security management system for network management according to an embodiment of the present invention;

FIG. 4 is a flow diagram of the user verification operation of the universal security management system for network management according to an embodiment of the present invention;

FIG. 5 is a flow diagram of the user authentication operation of the universal security management system for network management according to an embodiment of the present invention;

FIG. 6 is a block diagram of the security management gateway for network management according to an embodiment of the present invention.

FIG. 7 is a block diagram of the security management center for network management according to an embodiment of the present invention.

FIG. 8 is a block diagram of the function entity for network management according to an embodiment of the present invention.

### DETAILED DESCRIPTION OF THE EMBODIMENTS

For implementing a centralized security management for network management in a network constituted by devices provided by multiple manufacturers, which has the functions, such as authorization, verification and authentication of network management users, the main idea of the present invention is: to divide the network devices, i.e., function entities, within the whole network into different security domains, each of which includes multiple function entities and at least one security management gateway, according to the manufacturers of the network devices or to the security management interfaces supported by the network devices; the security management gateway is adapted to adapt security management interfaces of the function entities in the security domains to a normal interface provided by a security management center; the so-called security management center is the part implementing centralized user management, right management and identity verification, which also provides a user interface to a system administrator through a security management user interface.

In the embodiments of the present invention, the system administrator, that is, the administrator, is the person who is responsible for the management of the rights of the operators or of the network management users in the whole network, and the network management users, i.e., the users, are the operators who implement network management of the whole network through operations on the function entities. The administrator implements management of the users and their right information at the security management center through the security management user interface, and the security management center implements interaction with different function entities through the respective security management gateways of the security domains.

The running of the security management system for network management according to the embodiments of the present invention comprises four flows as follows: user management, that is, the administrator managing the user information by directly operating a user database at the security management center; user authorization, that is, the administrator authorizing a user at the security management center, wherein the authorizing comprising that the security management center inquiring the security management gateways bout the information of authorizable operations and providing the information to the administrator as a reference; user verification, that is, when a user logs in a function entity prior to his performing of a network management operation, the function entity sending a verification request to the security management center, and the security management center authenticating the user and returning a verification result, and if the verification is successful, the verification result returned by the security management center containing the user right information at the same time and the function entity buffering the user right information; user authentication, that is, the function entity authenticating each operation of the user according to the local buffered right information of the user, and making a decision.

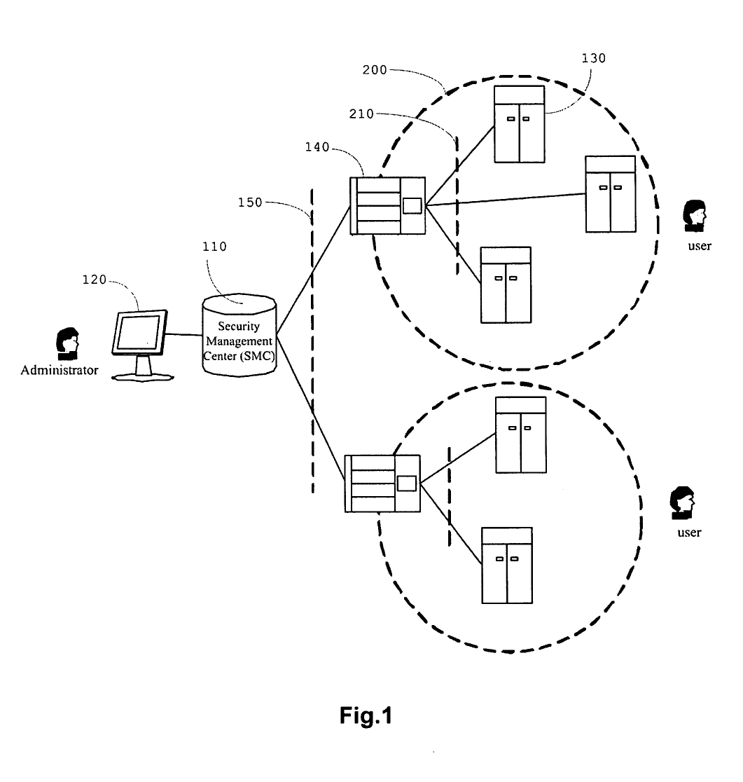

The following will give a detailed description on the technical details of the universal security management system for network management according to the embodiments of the present invention. As shown in FIG. 1, the main structure of the security management system includes Security Management Center (SMC) 110, Security Management User Interface (SMUI) 120, Function Entities (FEs) 130 made by multiple different manufacturers and Security Management Gateways (SMGs) 140 adapted for adaptation. In an embodiment of the present invention, the interconnection relationship of these components is shown in FIG. 1.

The FEs 130 in the whole network are divided into different Security Domains (S-Domains) 200 according to their manufacturers. Each of S-Domains 200 includes a corresponding SMG 140, which is adapted to adapt the Security Management Interface (SMI) 210 of the FEs in the S-Domain to a Universal Security Management Interface (USMI) 150 provided by the SMC 110. It can be seen that S-Domain is a concept of dividing the carrier's whole network as viewed from security management. One S-Domain includes devices provided by a certain device manufacturer. The S-Domain interacts with the external completely through the SMG 140.

The FE 130 here generally refers to a physical or logical entity providing some network services in the network. These FEs 130 are all under the management of the NMS, receiving operations from users to implement network management. Before accessing any FE 130, a user needs to be subjected to user identity verification; and after passing the user identity verification, the user needs to be subjected to an access authentication in conjunction with the user identity in each access.

SMC 110 is adapted to implement the user management, the right management and the identity verification of the whole network, which is a module that manages the users in the whole network centrally. And SMUI 120 provides a user interface such as Graphic User Interface (GUI), Command Line Interface (CLI), and WEB Portal, etc. to the administrator based on the SMC.

From FIG. 1, it can be seen that the whole network is divided into multiple S-Domains 200, each of which generally includes the FEs 130 only provided by the same manufacturer. In each S-Domain 200, there is arranged a SMG 140, which is mainly responsible for adapting the manufacturer-specific SMI 210 to the USMI 150 provided by the carrier's centralized SMC. The SMG 140 is an adaptation module for each S-Domain 200 with the SMC 110; and the FEs 130 in the S-Domains need to forward user identity verification requests and to download user right information through the SMG 140. A uniform SMC 110 is arranged in the whole network domain, which provides the USMI 150 to implement centralized user management, right management and identity verification of the whole network, and interacts with the SMG 140 of each S-Domain 200 to process the identity verification requests forwarded by the SMG 140 and to send the user right information downward. At the same time, the SMC 110 also receives the administrator's management operation on the user data through the SMUI 120.

The necessary functions needed to be implemented in each of the above components will be further described in the following.

The FE 130 first receives the user operation, forwarding the user verification request to the SMG 140 of the S-Domain that the FE 130 pertains to when the user logs in, and then the user verification request will be sent upward to the SMC 110 by the SMG 140; at the same time, the FE 130 also downloads the right information of the user presently logging from the SMC 110 through the SMG 140 and buffering the right information at the local; in this way, the FE 130 can authenticate the user operation according to the buffered right information each time the user operates, and clear the buffer of the right information according to a pre-configured policy each time the user logs out or the valid time limit expires, which can ensure the user right information is again downloaded and updated from the SMC 110 when the user logs in next time.

The main function of the SMG 140 is to adapt the specific SMI 210 inside the S-Domain to the USMI 150 outside the S-Domain. The SMG 140 interacts with all the FEs 130 through the specific SMI 210 within the S-Domain that the SMG 140 pertains to, and interacts with the SMC 110 through the USMI 150 outside said S-Domain. in this way, the SMG 140 can forward the requests sent upward by the FEs 130 which include the user verification requests sent by the FEs 130 to the SMC 110, and also forward the user information sent downward by the SMC 110 which include the user right information sent by the SMC 110 to the FEs 130. The SMG 140 is a key component for implementing the universal security management.

The SMC 110 is the carrier of the uniform centralized management of the whole network, adapted to manage the user information, the authorization information and the identity verification information of the whole network. There is a whole-network user information database stored on the SMC 110; and the administrator only needs to operate on the database to implement the operations on users pertaining to different S-Domains in the whole network. All the FEs 130 need to download and update the user information from the SMC 110 in order to implement the verification and the authentication. On one side the SMC 110 interacts with FEs 130 within the whole network through the respective SMGs 140 of the S-Domains, and on the other side the SMC 110 interacts with the administrator through the SMUI 120.

The following will explain how to implement the functions of the above-mentioned components and the cooperation their between according to the four basic work flows of the universal security management system. The four basic work flows include user management, user authorization, user verification and user authentication, wherein the user management and the user authorization are top-down management operations to the users on the administrator side, and the user verification and the user authentication are bottom-up request procedures of requesting verification and authentication on the user side when the users log in.

User management refers to the operations performed by the administrator directly on the user database at the SMC, including the operations, such as Add User, Delete User, Modify user information, etc.

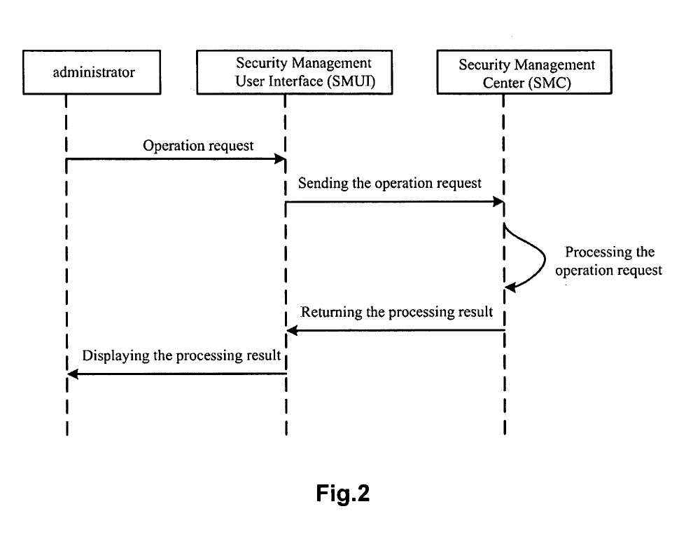

In an embodiment of the present invention, the modules and the work flow involved in these user management operations are shown as FIG. 2. First, the operation request initiated by the administrator is received at the user interface of the SMUI, and then forwarded to the SMC; the SMC processes the request, that is, it performs the user management operation, and returns the processing result to the SMUI; finally, the SMUI displays the processing result on the user interface.

User authorization refers to the operations, such as adding rights for user, and modifying user rights by the administrator. The rights of a user define the types and the objects of the operations performed by the user on the FEs. For example, access right of a user for files on FEs should be described as: what operating rights on which files the user possesses, such as Add, Delete, and Modify, etc. Therefore, users' right information should include at least two parts information, i.e., “operating type” and “operating object”.

Although as viewed from the administrator, the user authorization is similar with the user management; they both send operation requests downward through the SMUI, and after the processing by the SMC, receive operation results. But with respect to the internal processing procedure of the system, the user authorization has one more flow compared with the user management, that is, the SMC needs to inquire the SMG about the information of the authorizable operating types and operating objects, and presents the information on the authorization user interface for the administrator's reference, such that the administrator can implement the user authorization. It is surly possible that the SMG need to further inquire the FE about the information of the “operating type” and the “operating object”, which is omitted in the description of the embodiment of the present invention.

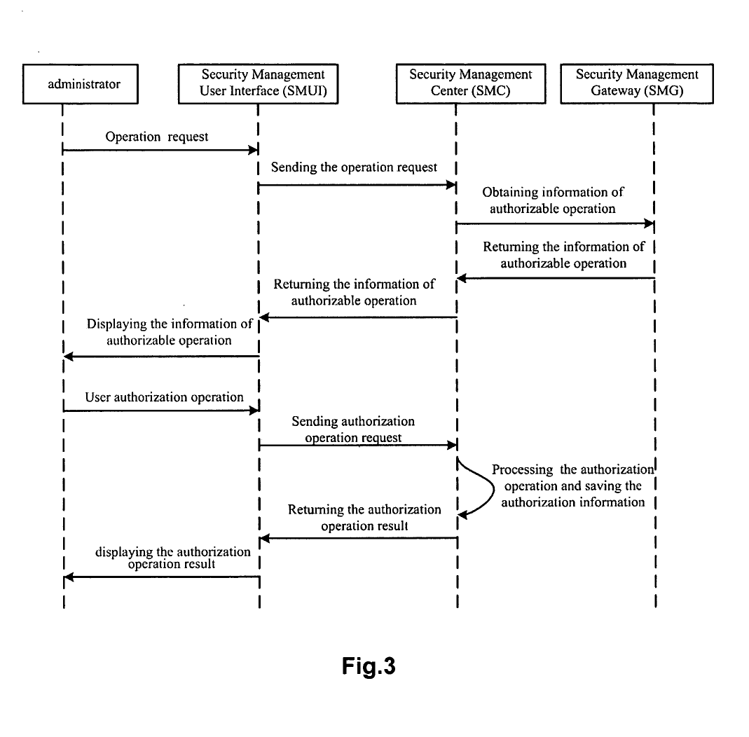

In an embodiment of the present invention, the modules and the work flow involved in these user authorization operations are shown as FIG. 3. First, the administrator operates on the user interface, and the user authorization operation request of the administrator is received at the SMUI and then sent to the SMC through the SMUI; then, the SMC obtains information of authorizable operating types and operating objects from the SMG, and returns the information to the SMUI; then, the information of the authorizable operation type and operating object is displayed on the administrator interface through the SMUI for the administrator's reference. In this way, the first half flow is completed, and now the administrator can choose how to authorize the user according to the selecting of the provided authorizable information; and after the authorization operation, the authorization operation request is sent to the SMC through the SMUI in return; then, the SMC processes the authorization operation, saves the user authorization information, and returns the processing result to the SMUI; finally, the processing result is displayed on the administrator's interface through the SMUI.

It is noticed that in the above flow the SMC needs to inquire the SMGs each time of the user authorization, which, in another embodiment of the present invention, is simplified by saving the authorizable information at the SMC and setting up a synchronization mechanism with the SMG. In the work flow of the user authorization, the SMC obtains the information of authorizable operating type and operating object from the SMG and saves the information in local each time of initiating; and after that, the SMG initiates a synchronization procedure to the SMC after each time of updating and modifying the information, so as to maintain the synchronization of the information of the authorizable operating type and operating object between the SMG and the SMC. In this way, the inconvenience of inquireing the SMC each time of authorization operation is avoided, saving the operating time.

User verification and user authorization refer to the operation procedure that after a user logs in a certain FE when performing network management operation, the FE needs to obtain the user information for authenticating from the uniform user database of whole network, i.e. from the SMC; and after that, the FE makes an authentication decision according to the user information each time the user operates. In this way, an apparent mechanism is that the FEs in the whole network all authenticate the users through the SMC and download the user right information from the SMC, and the interaction between the FEs and the SMC in this mechanism is adapted through the SMG. In addition, in this mechanism, the FEs also need to buffer the user information, which not only speeds up the authentication, but also ensures the timely update of the user right information; therefore, the FEs need to ensure that the user information is downloaded renewedly at the time of log in and cleared at the time of log out.

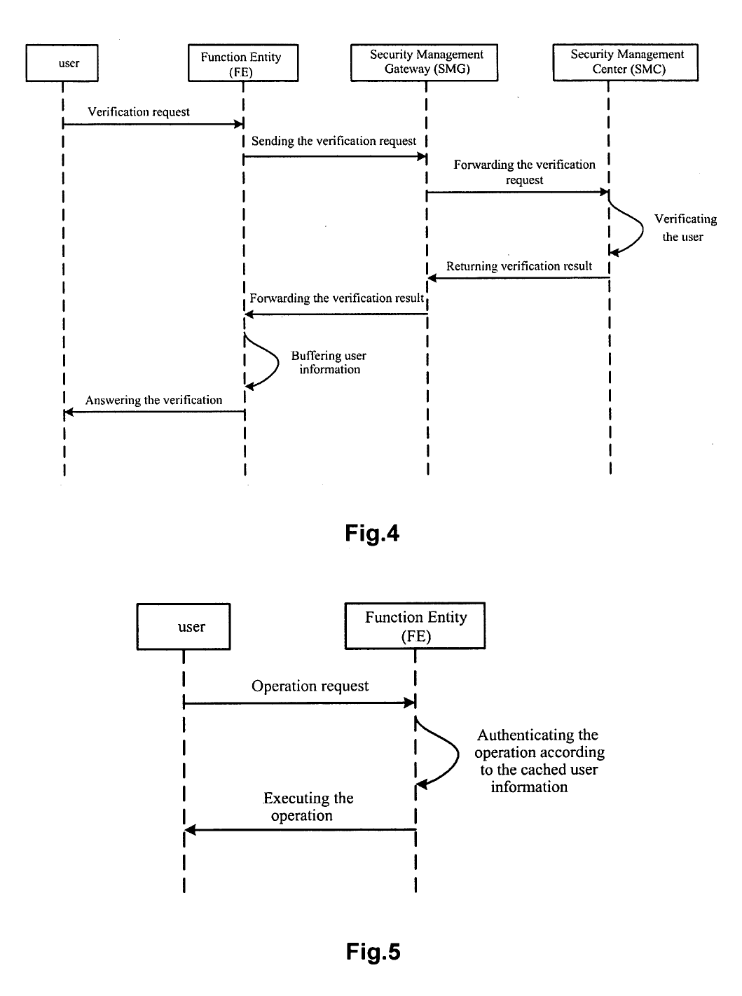

FIG. 4 and FIG. 5 respectively illustrate the work flows of the user verification and the user authentication according to the embodiments of the present invention.

First, the user logs in an FE, at which time the user provides identity identifiers such as user name and verification information such as password, digit Certificate so as to verify its identity; the FE receives the user verification request and forwards the request to the SMG in the S-Domain the FE pertains to; the SMG forwards the user verification request to the SMC; then, the SMC processes the user verification request, that is, to perform the user verification, and return the user right information to the SMG, which further forwards the information to the FE; after that, the FE obtains the user verification result and the user right information, and buffers the user right information in local until the user logs out or the time limit expires.

In the above interaction procedure, the key point is that the FE can forward the verification request according to the local configured policy, and save the user right information returned from the SMG. Only when the FE implements the forwarding of the verification request and the buffering of the user right information returned from the SMG, the centralized security management mechanism can be implemented. When an operation session ends, the FE clears its saved user right information, and downloads the user right information renewedly at the time of next login, so as to keep the user right updated timely.

After the user verification is accomplished, each operation of the user needs to be authenticated. The user authentication refers to that the FE authenticates the user operation according to the locally buffered user right information, to determine whether to allow the user to perform the operation. The content of the authentication includes “operating type” and “operating object”, and only when the user has both the rights, he is considered to have the right for the operation. As shown in FIG. 5, the FE authenticates the user operation according to the locally buffered user right information, and executes the operation after the user passes the authentication; and clears the locally buffered user right information according to the pre-configured policy.

Thus, the four work flows are implemented by means of the function systems of the components and the cooperation thereof, which not only provides the information management of the users in the whole network by the administrator, but also provides the necessary verification and authentication mechanism when the user operates the FEs in the whole network.

It should be noted that for the purpose of simplification, there is one SMG in each S-Domain in the above embodiments; but the present invention should not be limited to this, that is, each S-Domain can have multiple SMGs. To those skilled in the art, it is comprehensive that there are no essential difference between the implementation with multiple SMGs and the implementation with one SMG, and therefore, the description of the implementation of multiple SMGs will not be described here.

It should be furthermore noted that said devices or entities, such as the SMC, the SMG, the FE, etc. all refer to the logic entities. And in implementing, each logic entity can be implemented in a single physical device, or multiple logical entities can be implemented in the same physical device.

Through dividing the whole network into security domains and adding an SMG in each security domain, the carrier can implement centralized user management, right management and user verification mechanisms using a uniform approach according to the embodiments of the present invention, without large-scale modifications to the existing devices, thus simplifying the network management, avoiding the confusion due to the variance of multiple system right information, and improving the security and reliability of the network.

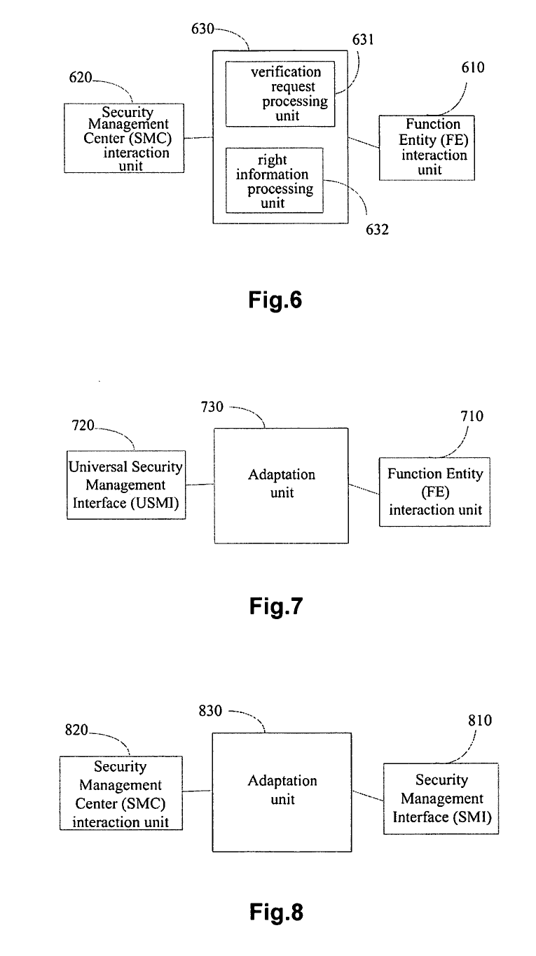

The SMG of an embodiment of the present invention corresponds to at least one FE, and implements the interaction between said FE and the SMC of NMS. Referring to FIG. 6, in an embodiment of the present invention, the SMG includes:

the FE interaction unit 610, adapted to implement the data interaction with the FEs;

the SMC interaction unit 620, adapted to implement the data interaction with the SMC; and

the processing unit 630, adapted to implement the adaptation of data transmitted between the FE interaction unit and the SMC interaction unit.

Wherein the FE interaction unit 610 interacts with the corresponding FEs through the SMI (not shown in the figure) of the FEs; the SMC interaction unit 630 interacts with the SMC through the USMI (not shown in the figure) provided by the SMC.

In the embodiment of the present invention, the processing unit 630 includes:

the verification request processing unit 631, adapted to convert the user verification requests received by the FE interaction unit 610 from the FEs, and send the converted requests to the SMC through the SMC interaction unit 620; and

the right information processing unit 632, adapted to convert the user verification results received by the SMC interaction unit 620 from the SMC, and send the converted results to the FEs through the FE interaction unit 610.

Moreover, according to an embodiment of the present invention, the SMG can be arranged at the SMC, or inside each of the FEs.

When the SMG is arranged at the SMC, the SMC according an embodiment of the present invention includes: the USMI 720, the FE interaction unit 710 adapted to implement data interaction with the FEs, and the adaptation unit 730 adapted to implement the adaptation of the data transmitted between the USMI and the FE interaction unit, as shown in FIG. 7.

When the SMG is arranged at the FE, the FE according to an embodiment of the present invention includes: the SMI 810, the SMC interaction unit 820 adapted to implement the data interaction with the SMC, and the adaptation unit 830 adapted to implement the adaptation of the data transmitted between the SMI and the SMC, as shown in FIG. 8.

Although the present invention has been illustrated and described with reference to the preferred embodiments of the present invention, those skilled in the art should understand that various changes in forms and details can be made without departing from the spirit and the scope of the present invention.

1. A universal security management system for network management, comprising a Security Management Center (SMC), at least one Function Entity (FE) and at least one Security Management Gateway (SMG); wherein
the whole network is divided into at least one Security Domain (S-Domain), each S-Domain comprising at least one said FE; and
each said S-Domain corresponds to at least one said SMG which is adapted to adapt a Security Management Interface (SMI) of the at least one FE in the S-Domain to a Universal Security Management Interface (USMI) provided by the SMC.

2. The system according to claim 1, further comprising a Security Management User Interface (SMUI) which is adapted to provide a user interface of security management to the administrator based on the SMC.

3. The system according to claim 2, wherein the SMC is adapted
to manage user information, authorization information and identity verification information of the whole network,
to interact with the FEs in the whole network through the SMGs of the S-Domains, and
to interact with the administrator through the SMUI.

4. The system according to claim 1, wherein the FE is adapted
to forward user verification requests to the SMG of the S-Domain the FE pertains to,
to download the right information of the user currently logging in from the SMC through the SMG and buffer the right information,
to authenticate a user operation according to the right information,
and to clear the buffer of the right information at the time of the user's logout or according to pre-configured policies.

5. The system according to claim 2, wherein the FE is adapted
to forward user verification requests to the SMG of the S-Domain the FE pertains to,
to download the right information of the user currently logging in from the SMC through the SMG and buffer the right information,
to authenticate a user operation according to the right information,
and to clear the buffer of the right information at the time of the user's logout or according to pre-configured policies.

6. The system according to claim 3, wherein the FE is adapted
to forward user verification requests to the SMG of the S-Domain the FE pertains to,
to download the right information of the user currently logging in from the SMC through the SMG and buffer the right information,
to authenticate a user operation according to the right information,
and to clear the buffer of the right information at the time of the user's logout or according to pre-configured policies.

7. The system according to claim 1, wherein the SMG interacts with all the FEs in the S-Domain the SMG pertains to through the SMI of the S-Domain, and interacts with the SMC through the USMI, for forwarding the user verification requests sent by the FEs to the SMC, and forwarding the right information sent by the SMC to the FEs.

8. The system according to claim 2, wherein the SMG interacts with all the FEs in the S-Domain the SMG pertains to through the SMI of the S-Domain, and interacts with the SMC through the USMI, for forwarding the user verification requests sent by the FEs to the SMC, and forwarding the right information sent by the SMC to the FEs.

9. The system according to claim 3, wherein the SMG interacts with all the FEs in the S-Domain the SMG pertains to through the SMI of the S-Domain, and interacts with the SMC through the USMI, for forwarding the user verification requests sent by the FEs to the SMC, and forwarding the right information sent by the SMC to the FEs.

10. A universal security management system for network management, comprising a Security Management Center (SMC), at least one Function Entity (FE) and at least one Security Management Gateway (SMG); wherein
said at least one FE is adapted to process user services;
said SMC is adapted to implement the security management of the whole network; and
said at least one SMG each corresponds to at least one FE, which is adapted to implement a data interaction between the SMC and the at least one FE the SMG corresponds to.

11. The system according to claim 10, wherein the SMG interacts with the corresponding FE through a Security Management Interface (SMI) of the FE, and interacts with the SMC through a Universal Security Management Interface (USMI) provided by the SMC.

12. A Security Management Gateway (SMG) for network management, which corresponds to at least one Function Entity (FE), and implements an interaction between the FE and a Security Management Center (SMC) of a Network Management System (NMS), comprising:
an FE interaction unit, adapted to implement a data interaction with the FE;
an SMC interaction unit, adapted to implement a data interaction with the SMC; and
a processing unit, adapted to implement the adaptation of the data transmitted between the FE interaction unit and the SMC interaction unit.

13. The SMG for network management according to claim 12, wherein the FE interaction unit interacts with the corresponding FE through the SMI of the FE; the SMC interaction unit interacts with the SMC through a Universal Security Management Interface provided by the SMC.

14. The SMG for network management according to claim 12, wherein the processing unit comprises:
a verification request processing unit, adapted to convert a user verification request received by the FE interaction unit from the FE, and then to send the converted user verification request to the SMC through the SMC interaction unit; and
a right information processing unit, adapted to convert a user verification result received by the SMC interaction unit from the SMC, and then to send the converted user verification result to the FE through the FE interaction unit.

15. The SMG for network management according to claim 13, wherein the processing unit comprises:
a verification request processing unit, adapted to convert a user verification request received by the FE interaction unit from the FE, and then to send the converted user verification request to the SMC through the SMC interaction unit; and
a right information processing unit, adapted to convert a user verification result received by the SMC interaction unit from the SMC, and then to send the converted user verification result to the FE through the FE interaction unit.

16. A Security Management Center (SMC), comprising a Universal Security Management Interface (USMI), wherein the SMC further comprises:
a Function Entity interaction unit, adapted to implement a data interaction with a Function Entity (FE); and
an adaptation unit, adapted to implement an adaptation of the data transmitted between the USMI and the FE interaction unit.

17. A Function Entity (FE) of a security management system for network management, comprising a Security Management Interface (SMI); wherein the FE further comprises:
a Security Management Center interaction unit, adapted to implement a data interaction with a Security Management Center (SMC); and
an adaptation unit, adapted to implement an adaptation of the data transmitted between the SMI and the SMC.

18. A method for user management of a universal security management system for network management, comprising the following steps of
receiving, through a Security Management User Interface (SMUI), a user management operation request from an administrator, and sending the user management operation request to a Security Management Center (SMC);
processing, at the SMC, the user management operation request, and returning a processing result to the SMUI; and
displaying the processing result, by the SMUI, on a user interface.

19. A method for user authorization of a universal security management system for network management, comprising the following steps of
receiving, through a Security Management User Interface (SMUI), a user authorization operation request from an administrator, and sending the user authorization operation request to a Security Management Center (SMC);
obtaining, by the SMC, the information of authorizable operating type and authorizable operating object from a Security Management Gateway (SMG), and returning the information of authorizable operating type and authorizable operating object to the SMUI;
displaying, by the SMUI, the information of authorizable operating type and authorizable operating object on an administrator interface for the administrator's reference when the administrator performs an authorization operation;
sending, through the SMUI, the user authorization operation request to the SMC after the authorization operation is accomplished by the administrator;
processing, at the SMC, the authorization operation, saving the user authorization information, and returning a processing result to the SMUI; and
displaying, by the SMUI, the processing result on an administrator interface.

20. A method for user authorization of a universal security management system for network management, comprising the following steps of
obtaining, by a Security Management Center (SMC), information of authorizable operating type and authorizable operating object from a Security Management Gateway (SMG) each time the SMC starts up, and saving the information by the SMC in local;
initiating, by the SMG, a synchronizing procedure with the SMC after each time of the update and the modification of the SMG, so as to maintain the synchronization of the information of authorizable operating type and authorizable operating object between the SMG and the SMC;
performing, by the administrator, an authorization operation according to the information of authorizable operating type and authorizable operating object provided by the SMC;
sending, through a Security Management User Interface (SMUI), an authorization operation request to the SMC after the authorization operation;
processing, at the SMC, the authorization operation, saving the user authorization information, and returning a processing result to the SMUI; and
displaying, by the SMUI, the processing result on an administrator interface.

21. A method for user verification of a universal security management system for network management, comprising the following steps of
receiving, by a Function Entity (FE), a user verification request, and sending the user verification request to a Security Management Gateway (SMG) of the Security Domain (S-Domain) that the FE pertains to, and forwarding, by the SMG, the user verification request to a Security Management Center (SMC);
processing, at the SMC, the user verification request and then returning a verification result and user right information to the SMG, and forwarding, by the SMG, the verification result and the user right information to the FE; and
buffering, by the FE, the user right information in local until the user logs out or a time limit expires.

22. The method according to claim 21, wherein the step of receiving by the FE the user verification request further comprises:
determining, by the FE, whether to forward the user verification request or not according to pre-configured local policies; if it is yes, forwarding the user verification request to the SMG, otherwise directly processing the user verification request in local.

23. The method according to claim 21, wherein before the step of buffering by the FE the user right information in local, the method further comprises determining whether to buffer the user right information or not according to the pre-configured local policies.

24. A method for user authentication of a universal security management system for network management, comprising the following steps of
authenticating, by a Function Entity (FE), a user operation according to user right information buffered in local, and executing the user operation, by the FE, after passing the authentication; and
clearing, by the FE, the locally buffered user right information according to pre-configured policies when the user logs out or a time limit expires.
